(19) United States
(12) Patent Application Publication
(10) Pub. No.: US 2019/0089807 A1
(43) Pub. Date: Mar. 21, 2019

(54) METHOD AND APPARATUS FOR DYNAMIC PORTABLE USER SYSTEM CONFIGURATION

(71) Applicant: FORD GLOBAL TECHNOLOGIES, LLC, Dearborn, MI (US)

(72) Inventor: Hanan J. AHMED, Belleville, MI (US)

(21) Appl. No.: 15/710,479

(22) Filed: Sep. 20, 2017

(51) Int. Cl. H04L 29/08; G05D 1/00; G06Q 10/00

(52) U.S. Cl. CPC H04L 67/306; G05D 2201/0213; G06Q 10/00; G05D 1/0088

(57) ABSTRACT

A system includes a processor configured to detect a user device including predefined vehicle system settings. The processor is also configured to wirelessly download the vehicle system settings to a vehicle, including deletion parameters. The processor is further configured to implement the downloaded vehicle system settings and delete vehicle system settings in accordance with the deletion parameters, responsive to a deletion trigger.

### TECHNICAL FIELD

The illustrative embodiments generally relate to methods and apparatuses for dynamic portable user system configuration.

### BACKGROUND

While it used to be the case that people owned and used their own personal vehicles, and sharing was generally limited to family members, new models for vehicular usage are becoming ever more prevalent. Services allowing short-term rentals, ride-sharing services, on-demand transportation and even shared ownership models are all now implemented as alternatives to traditional vehicle ownership.

Further, it may be the case that initial autonomous vehicles have high costs associated therewith, making it reasonable to share usage of these vehicles. Plus, when one considers that the typical vehicle simply sits in a parking location for the majority of the day, a shared ownership model, fully utilizing the vehicle, may make more sense. This is especially true if the vehicle is capable of traveling to another user in the absence of a driver. It may even be the case that the models for usage create situations where users use vehicles from a pool of vehicles, and so the likelihood of a user repeatedly using the same vehicle may be low.

In light of these changes, traditional models of vehicle system configuration may not be particularly useful. Onboard saved user profiles may be pointless, if the user does not ever end up using the vehicle again, or goes months before incidentally encountering the vehicle. Storing profiles for every possible user would require a potentially massive amount of memory, and would utilize an excessive amount of unnecessary redundancy.

Also, users may use a single vehicle, one time, for a single short journey. Or, in current models, the user may use an on-demand transportation service, again with a high likelihood of never repeating the trip in that vehicle. In these instances, it makes little sense for a user to take the time and effort to configure vehicle settings, as an expectation of using the vehicle again is low.

### SUMMARY

In a first illustrative embodiment, a system includes a processor configured to detect a user device including predefined vehicle system settings. The processor is also configured to wirelessly download the vehicle system settings to a vehicle, including deletion parameters. The processor is further configured to implement the downloaded vehicle system settings and delete vehicle system settings in accordance with the deletion parameters, responsive to a deletion trigger.

In a second illustrative embodiment, a computer-implemented method includes determining that a predefined deletion trigger, downloaded from a mobile device in conjunction with vehicle system settings, has been met. The method also includes selectively deleting vehicle system setting values, set in accordance with the downloaded vehicle system settings, in accordance with system deletion parameters, also downloaded from the mobile device, responsive to the deletion trigger.

In a third illustrative embodiments, a computer-implemented method includes receiving a vehicle system configuration instruction on a mobile phone. The method also includes presenting an interface including vehicle systems configurable via the mobile phone, responsive to the configuration instruction. Configuration options for configurable vehicle systems include an option to set deletion parameters for deleting settings changed in a vehicle in accordance with a user defined configuration downloaded from the mobile phone and an option to set tracking parameters for tracking settings changed in the vehicle during a drive.

### BRIEF DESCRIPTION OF THE DRAWINGS

FIG. 1 shows an illustrative vehicle computing system;

FIG. 2 shows an illustrative example of a setting implementation process; and

FIG. 3 shows an illustrative setting configuration process.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

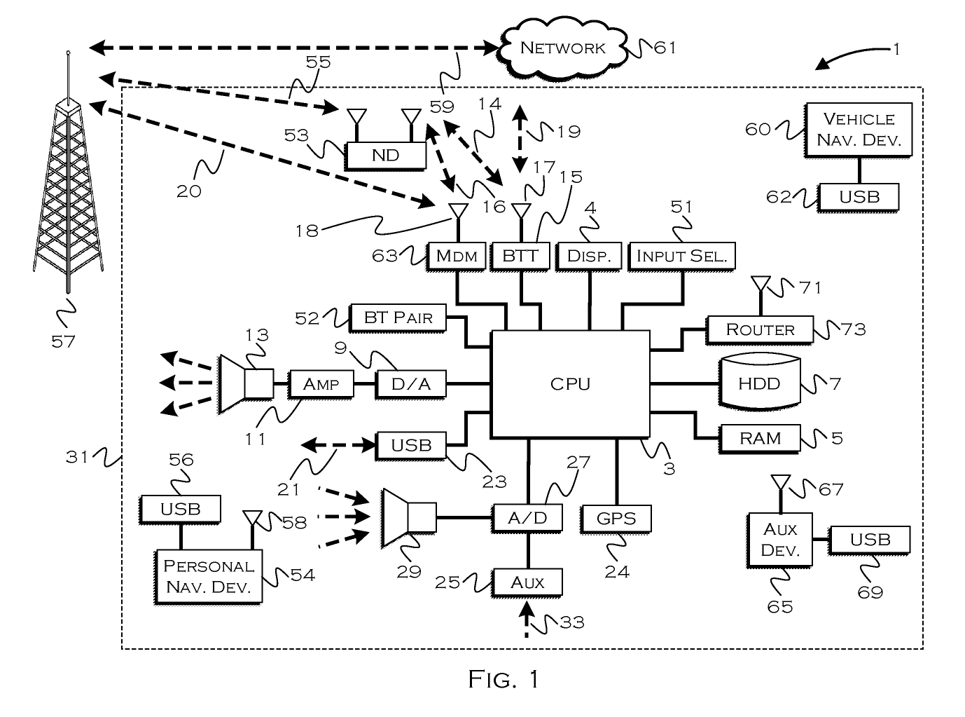

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11 g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In many ride-sharing models, it would be useful to have a method for a user to import system settings, change system settings and have desired changes persist. On the other hand, user personal information, such as contacts, navigation addresses, etc., may be downloaded to the vehicle, but should not persist for other users to peruse. The same is true for personal account information, such as Wi-Fi passwords and other access credentials.

The illustrative embodiments propose a solution allowing a user to create portable system settings, to change and update those settings, and to completely or selectively erase all settings upon exiting a vehicle. If a user is going to re-use a vehicle, or plans to re-use a vehicle, the user could save certain settings to an onboard profile. If the user does not care about certain data persisting, or even wanted certain data to persist for other users, the user could selectively define what data is kept by the system.

For example, if a family shares a vehicle, each driver may want their personal contacts, radio stations and navigation history removed when exiting the vehicle. At the same time, allowing Wi-Fi passwords for mobile network access, navigation favorites for common family member destinations (e.g., home) and similar multi-party-useful information to persist might be desirable. That way, if one family member knows a Wi-Fi password, for example, the other family member does not also have to recall or obtain the password in order to use a family-accessible Wi-Fi network.

On the other hand, a person using a vehicle once, or sharing a vehicle usage plan with strangers, may want all of the above information available when they are in the vehicle and erased upon exiting the vehicle. By allowing selective deletion of imported settings upon exit, the process allows each user to determine which settings persist and which settings are deleted. In one model, this begins with an opt-out requirement, which is to say that all data is deleted until the user opts-out of deletion of a particular data element. Users can also set defined lifetimes for elements to be deleted, which can define an expiration data upon which a system will automatically remove the element.

In these examples, the user's mobile phone acts as portable data storage. This is a device that is easily consistently connectable to a vehicle, and the device can even be used to detect an approach-direction of the user, so that distinction can be made between settings when a user is a driver and settings when a user is a passenger. When the vehicle is parked and/or when the phone is disconnected, user-defined, OEM defined, or all settings can then be deleted. The vehicle can revert to a base-state, or, if the system saves backups of data, flagged for deletion when the data was altered to accommodate the user, the system can reload any previous settings to replace the deleted settings, if such reload is appropriate. For example, when navigation history is deleted, it is unlikely that some other navigation history will be reloaded, but if radio stations are deleted, it may be desirable to reload a set of known, working radio stations.

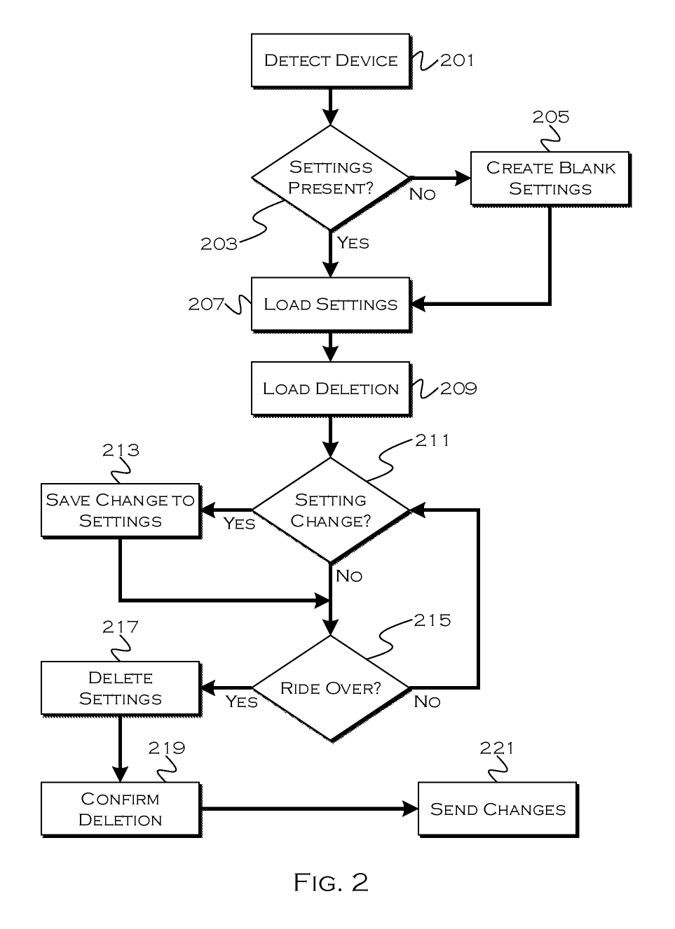

FIG. 2 shows an illustrative example of a setting implementation process. In this illustrative example, the process is executed as a device is detected approaching the vehicle, or in the vehicle, or upon request by the occupant in response to communication with a vehicle (e.g., the settings do not necessarily have to be automatically implemented). Requested upload of settings could be done via the device or a vehicle human machine interface.

Once the process detects 201 the device (and receives implementation instructions, if that is the model implemented), the process determines 203 if there are any user defined settings that exist in a user profile on the device. These could be global settings and they could also include settings for a specific vehicle or vehicle feature. For example, while most vehicles have a radio, not all vehicles have HD radio, so the user could have one set of preset settings for radio stations that are globally implemented, and supplementary or replacement data for HD radio settings that are implemented if HD radio is present in a vehicle. In this manner, the user can adaptively configure settings to vehicles of varied capability.

If there are no settings currently present on the device, the process can locally (or remotely on the device) create 205 a “blank” profile, which may literally be empty of settings, or may include a number of default settings. Otherwise, the process loads 207 any existing settings (which could include loading the newly created default settings) from the device.

Also, in this example, the process loads 209 a deletion profile, defining which settings are to be erased when a user disconnects. This user defined profile may designate certain data for deletion, and the system can responsively either save the pre-load states of vehicle system settings for settings that are to be deleted, or the system can revert those settings to default settings following deletion. As previously noted, the response of a system to setting deletion may vary based on the settings, such that some settings are reverted to pre-load states and other settings are reverted to system defaults. Any information not tagged for deletion will persist after user disconnection unless otherwise deleted by the system for other reasons.

Individual settings may also have flags or settings associated therewith that indicate whether the settings are persistent or dynamic. Persistent settings maintain a previous state regardless of user adjustment during a drive, while dynamic settings change state (in future drives) based on user adjustments made during a current drive. Users can configure the persistent/dynamic nature of any appropriate setting. For example, a user on a cross-country drive may make radio settings persistent, so that any changes during the drive (which will likely not be useful again in the future) are ignored, but when the user is traveling in a locality in which the user lives, the user may have the radio settings set to dynamic states, which allows the user to automatically save changes made to the radio settings based on changes in user preferences.

The persistent/dynamic flags associated with settings may be loaded at the time of setting-load. In other models, the user may be given an option to save or discard any or all changes made during a drive, either when the change is made or at the completion of the drive.

If the process detects 211 a change to any setting having a dynamic flag associated therewith, the process may save 213 the change to a new setting upload file. In other models, the process may simply upload all changed settings having dynamic flags associated therewith, based on their present states, before deletion of the appropriate settings. The process of tracking the setting changes persists until the drive is complete 215.

Once the drive is over (and/or when the user device is disconnected, either or both occurrence are examples of triggers for deletion), the process can delete 217 any settings tagged for deletion. In this example, the process also confirms 219 that the settings were deleted following execution of a deletion instruction, which could include, for example, comparing the saved user settings (from the device) to current setting states following deletion execution. This is not necessary, but serves as an additional confirmation of deletion. If any settings are not deleted, the process may inform the user that the particular setting was unable to be deleted (following a re-attempt at deletion, for example). Finally, in this example, the process sends 221 any changes to dynamic settings to the mobile device to change the settings saved thereon.

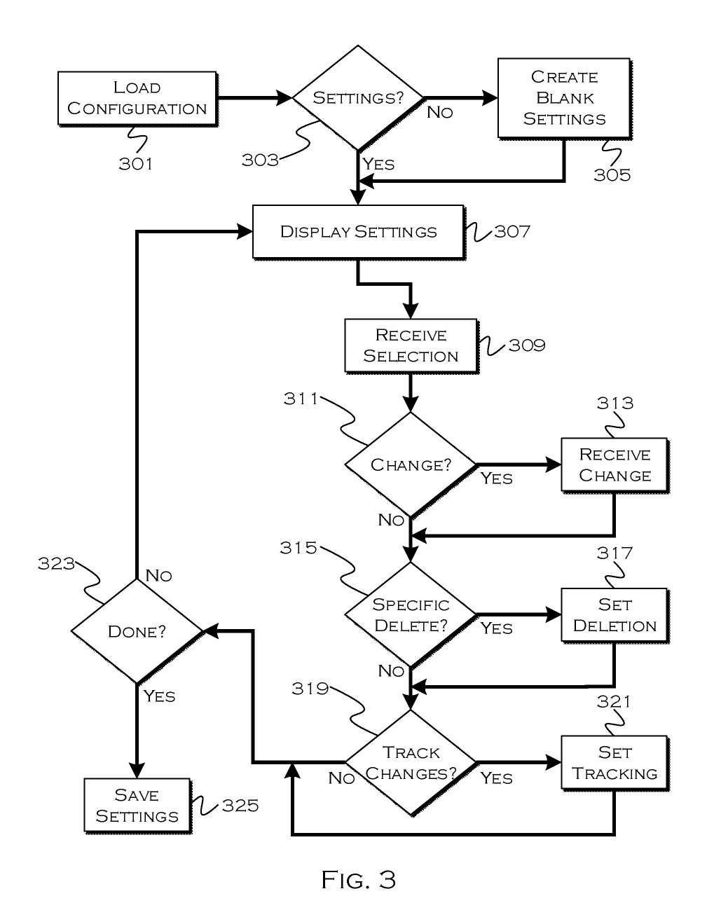

FIG. 3 shows an illustrative setting configuration process. In this example, the process allows a user to configure the setting states for various vehicle systems (global and/or specific) as well as set deletion flags and/or dynamic/persistent flags. The process loads 301 a configuration routine, which can be run on a mobile device, a vehicle HMI or on another device capable of interacting with settings saved on the mobile device.

If there is a current set of settings 303, the process will display 307 those settings. If a user is configuring a new profile, and there is no current set of settings, the process may create 305 a set of blank settings (or default settings) which the user can alter as desired. Users may also specify one or more trusted parties (by name, login, mobile number or other identifier) who can access one or more aspects of the user's saved information, if that information is not deleted upon user-request. This would allow for preservation and sharing of at least certain information. Permissions can be granted on a per-element and per-user basis.

The process receives 309 selection of a setting to be altered by a user, and determines 311 if a change has been made to a setting value. If the user has changed the value of the setting (e.g., changing an HVAC or radio setting), the process saves 313 the change to the setting value. In the same manner, the process determines if there was a change 315 to a deletion setting associated with the system setting, and saves 317 that change. Deletion changes may also be globally defined, such that all settings could be requested to be deleted upon exit of a vehicle, or, for example, settings pertaining to certain classifications could be defined for deletion (e.g., all navigation settings, all communication settings, etc.).

The process further detects 319 if any change was made to a tracking setting (dynamic/persistent/persistent with confirmation, etc) and saves 321 that change. As with the deletion settings, global or group settings can be defined for tracking, for example saving all changes to any media settings, or ignoring all changes to any navigation settings. As long as the user continues to make changes 323, the process continues, until all settings changed by the user are final saved 325 and displayed for user confirmation, if desired.

The illustrative embodiments allow users to dynamically import, delete, save and carry portable vehicle system settings through a variety of vehicles. Implementation of the saved settings, and subsequent deletion, can allow a user to quickly adapt a vehicle environment to a familiar one, without fear of privacy violation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
detect a user device including predefined vehicle system settings;
wirelessly download the vehicle system settings to a vehicle, including deletion parameters;
implement the downloaded vehicle system settings; and
delete vehicle system settings in accordance with the deletion parameters, responsive to a deletion trigger.

2. The system of claim 1, wherein the deletion parameters instruct individual deletion settings for one or more downloaded vehicle system settings.

3. The system of claim 1, wherein the deletion parameters instruct deletion settings for groups of functions having common characteristics.

4. The system of claim 1, wherein the deletion parameters instruct deletion of all implemented settings.

5. The system of claim 1, wherein the deletion trigger includes disconnection of the mobile phone from a wireless connection with the processor.

6. The system of claim 1, wherein the deletion trigger includes placing the vehicle in park.

7. The system of claim 1, wherein vehicle systems configurable according to the system settings include media systems.

8. The system of claim 1, wherein vehicle systems configurable according to the system settings include heating ventilation and air conditioning systems.

9. The system of claim 1, wherein vehicle systems configurable according to the system settings include security protocols.

10. The system of claim 1, wherein the deletion parameters specify deletion of vehicle system data other than systems modified by the vehicle system settings.

11. The system of claim 1, wherein the processor is configured to download tracking parameters for one or more of the system settings.

12. The system of claim 11, wherein the processor is configured to track changes to vehicle systems in accordance with the tracking parameters.

13. The system of claim 12, wherein the processor is configured to upload changes back to the mobile phone, responsive to the deletion trigger and prior to deletion.

14. The system of claim 1, wherein the processor is configured to download different system settings responsive to a detected user device approach vector indicating the user is a passenger or a driver.

15. The system of claim 1, wherein the processor is configured to notify a user, via a vehicle output, if deletion of a vehicle system in accordance with a deletion parameter is unsuccessful.

16. A computer-implemented method comprising:
determining that a predefined deletion trigger, downloaded from a mobile device in conjunction with vehicle system settings, has been met; and
responsive to the deletion trigger, selectively deleting vehicle system setting values, set in accordance with the downloaded vehicle system settings, in accordance with system deletion parameters, also downloaded from the mobile device.

17. The method of claim 16, further comprising:
responsive to the deletion trigger, selectively delete vehicle system modifications made during a drive in accordance with the deletion parameters.

18. The method of claim 17, wherein the vehicle system modifications include navigation inputs.

19. The method of claim 16, wherein the vehicle system settings include user security authentication information.

20. A computer-implemented method comprising:
receiving a vehicle system configuration instruction on a mobile phone; and
presenting an interface including vehicle systems configurable via the mobile phone, responsive to the configuration instruction, wherein configuration options for configurable vehicle systems includes an option to set deletion parameters for deleting settings changed in a vehicle in accordance with a user defined configuration downloaded responsive to detecting the mobile phone and an option to set tracking parameters for tracking settings changed in the vehicle during a drive.
